(19) United States
(12) Patent Application Publication
(10) Pub. No.: US 2009/0306452 A1
(43) Pub. Date: Dec. 10, 2009

(54) APPARATUS FOR TREATING A CONTAMINATED MEDIA WITH A SORBENT

(76) Inventor: Frederick C. Payne, Charlotte, MI (US)

Correspondence Address: SHERIDAN ROSS PC, 1560 BROADWAY, SUITE 1200, DENVER, CO, 80202, US

(21) Appl. No.: 12/468,732

(22) Filed: May 19, 2009

Related U.S. Application Data
(60) Provisional application No. 61/054,417, filed on May 19, 2008.

(51) Int. Cl. B09B 3/00; B01J 20/26

(52) U.S. Cl. 588/252; 502/402

(57) ABSTRACT

The invention relates a sorbent and method of using the sorbent, more specifically to an inert sorbent and a method for treating an environmentally contaminated zone with the inert sorbent.

### CROSS REFERENCE TO RELATED APPLICATION

The present application claims the benefit of U.S. Provisional Application Ser. No. 61/054,417 filed May 19, 2008, entitled “Inert Sorbent and Treatment Media”, which is incorporated herein by this reference.

### FIELD OF THE INVENTION

The invention relates a sorbent and method of using the sorbent, more specifically to a method for treating an environmentally contaminated zone with the sorbent.

### BACKGROUND OF THE INVENTION

A significant number of land and wet land sites are contaminated with environmentally hazardous material. Examples of the hazardous materials contained in the sites include polychlorinated biphenyls (“PCB's”), dioxins, pesticides, pharmaceuticals, synthetic organic compounds, and various inorganic materials (such as, arsenic, mercury, methyl mercury, lead, tetraethyl lead, radioactive metals, and other metals and metalloids). The hazardous materials are detrimental to the ecosystem, especially wildlife, such as fish, foraging waterfowl, small vertebrates and humans. Many of the hazardous materials are hydrophobic. The hydrophobic materials are substantially immiscible with and insoluble in, water, which limits the ability to treat the hazardous material in situ.

In situ treatment methods are relatively difficult and expensive to install and maintain. In some instances, the in situ method can substantially disturb and/or distribute the hazardous material, further damaging the environment. Thus, it would be desirable to provide a durable and relatively simple method for the in situ treatment of a contaminated area, preferably with an inexpensive material.

### SUMMARY OF THE INVENTION

One aspect of the present invention is an inert sorbent particle comprising a polymer, the polymer having solubility and diffusion properties for adsorbing non-polar, hydrophobic materials to a greater extent than polar materials. The polymer has durability, strength, abrasion resistance, absorptive capacity, and diffusive ability and is relatively benign to living organisms. The polymer has a solubility property favoring the absorption of one or more hydrophobic materials. Preferably, the one or more hydrophobic materials are environmental hazards, such as polychlorinated biphenyls (“PCB's”), dioxins, pesticides, pharmaceuticals, organometallics (such as, methyl mercury and tetraethyl lead) and synthetic organic compounds.

The polymer absorbs hydrophobic materials having a Log P greater than about Log P 0. In a preferred embodiment, the polymer absorbs materials having a Log P greater than about than about Log P 1. In a more preferred embodiment, the polymer absorbs materials having a Log P greater than about Log P 2.

In a preferred embodiment, the polymer has an equilibrium partitioning with the hydrophobic material. In a more preferred embodiment, the polymer has a linear absorption isotherm for the absorption of the hydrophobic material.

The polymer is at least one of a homopolymer, a copolymer, a polymer mixture and a polymer alloy. The polymer comprises one or more of polyolefins, polystyrenes, polyvinyls, polyacrylics, polyhalo-olefins, polydienes, polyoxides/esthers/acetals, polysulfides, polyesters/thioesters, polyamides/thioamides, polyurethanes/thiourethanes, polyureas/thioureas, polyimides/thioimides, polyanhydrides/thianhydrides, polycarbonates/thiocarbonates, polyimines, polysiloxanes/silanes, polyphosphazenes, polyketones/thioketones, polysulfones/sulfoxides/sulfonates/sulfoamides, polyphylenes, and mixtures thereof. In a preferred embodiment, the polymer comprises at least one of polyethylene, high-density polyethylene, low-density polyethylene, polypropylene, nylon and mixtures thereof.

The polymer preferably comprises a polymeric particle. In one embodiment, the polymer encapsulates an active ingredient to form the polymeric particle. The active ingredient is any material capable of substantially absorbing, adsorbing, reacting with, deactivating and/or decomposing the hydrophobic material. The active ingredient comprises one or more of an activated carbon, a granular activated carbon, a zero valent metal (such as, zero-valent iron), a microbe, bacteria, a fungus (such as, white rot fungus) and mixtures thereof. The zero-valent metal has a form comprising one or more of a powder, a particle, a filing, or a solid shape. In one preferred embodiment, the solid shape substantially resembles a sphere.

The encapsulated particle is one of a core-shell encapsulated particle, a matrix encapsulated particle and a combination thereof. The core-shell encapsulated particle comprises a core and a shell having a core-shell particle surface. The core-shell surface comprises the polymer substantially free of any active ingredient. The core substantially comprises the active ingredient substantially free of the polymer. The shell substantially surrounds by the core. In one embodiment, the shell comprises a plurality of polymeric layers, one layer positioned on top of another. The polymeric layers can comprise the same polymeric material or differ.

The matrix encapsulated particles comprise the active ingredient intermixed within a matrix comprising the polymer and have a matrix surface comprising substantially the polymer. In one embodiment, the matrix surface comprises substantially the polymer and at least some of active ingredient.

The particles can have any shape. Preferred polymer particle shapes are selected from the group consisting of shapes substantially resembling spheres, cylinders, tri-lobes, poly-lobes, tubes, and combinations thereof.

The particle has a size, a volume, a surface area and a mass. The particle size is at least about ⅛ of an inch. In a preferred embodiment, the particle size ranges from about ¼ inch to about 2 inches, even more preferred from about ⅜ inch to about 1 inch. The particle ratio of mass/volume is at least about 0.5. In a preferred embodiment, the mass/volume ratio for the particle is at least about 0.7, even more preferred the mass/volume ratio is at least about 1. The surface area of particle ranges from about 1×10⁻⁴ ft² to about 2 ft². In a preferred embodiment, the particle surface area ranges from about 1×10⁻³ ft² to about 1 ft² and more preferably from about 2×10⁻² ft² to about 0.5 ft².

Another aspect of the present invention is a process for treating a contaminated zone containing a dangerous level of at least one hazardous material with a plurality of polymeric particles. The contaminated zone comprises one of well waters, geothermal waters, surface waters (such as water from lakes, ponds, streams, rivers, land-locked seas) and wetlands and sediments associated therewith, agricultural waters and wetlands and sediments associated therewith, wastewater associated with industrial process and wetlands and sediments exposed to the industrial wastewater, coastal waters (such as, seas and oceans) and wetlands and sediments associated therewith, and landfills, disposal sites, hazardous material spillage sites and hazardous material leachate outbreak sites associated therewith.

Yet another aspect of the present invention is a process for treating a contaminated zone, comprising identifying the contaminated zone containing at least one hazardous material at a dangerous level, applying a plurality of particles to the contaminated zone, wherein applying includes contacting the plurality of particles with the contaminated zone, maintaining the plurality of particles in contact with the contaminated zone for a period time, removing the particles from the contaminated zone and after removing the particles from the contaminated zone determining the hazardous material content of the contaminated zone. In one embodiment, the contaminated zone is further treated with a device comprising a netting or a matting system having a the plurality of particles positioned between first and second opposing nets (or mats), wherein the first and second nets substantially encase and restrain the plurality of particles within at least one void volume positioned between the first and second nets.

In one embodiment, the netting or matting system is contacted with a contaminated zone and after a period of exposure to the contaminated zone the netting (or matting) is removed. In one configuration, the netting or matting is contacted with a contaminated zone, such as, a contaminated zone comprising substantially earth and/or soil. In such a configuration, the netting or matting is spread over the contaminated zone by manual labor, a mechanical device, or a combination of both. In yet another configuration, after spreading the netting or matting, a contaminated material is positioned on the netting or matting.

In another embodiment, the netting or matting is positioned within the contaminated zone. In one configuration, the netting or matting is positioned with a contaminated aqueous environment, such as, but not limited to, a lake, a stream, a river, a marsh, a pond, a wet land, a wet sediment, a combination thereof. While not wanting to limited by example, the netting or matting can be one of anchor, moor, tether, tie-down, chain-down, and harness within the aqueous environment. In another configuration, to a boat or other suitable water conveyance vehicle is attached to the netting or matting and the netting or matting is conveyed through the contaminated water zone.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The above-described embodiments and configurations are neither complete nor exhaustive. As will be appreciated, other embodiments of the invention are possible utilizing, alone or in combination, one or more of the features set forth above or described in detail below. Other advantages of the present invention will be apparent to one of ordinary skill in the art from the disclosure provided below.

### BRIEF DESCRIPTION OF THE DRAWINGS

FIG. 1 depicts a sorbent particle according to an embodiment of the present invention;

FIG. 2 depicts another sorbent particle according to another embodiment of the present invention;

FIG. 3 depicts yet another sorbent particle according to another embodiment of the present invention;

FIG. 4 depicts a process for treating a contaminated zone according to an aspect of the present invention;

FIG. 5 depicts a device according to an embodiment of the present invention; and

FIGS. 6A and 6B depict another device according to another embodiment of the present invention.

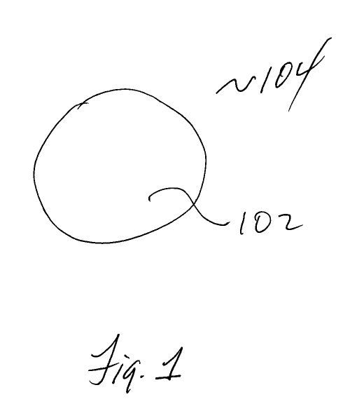

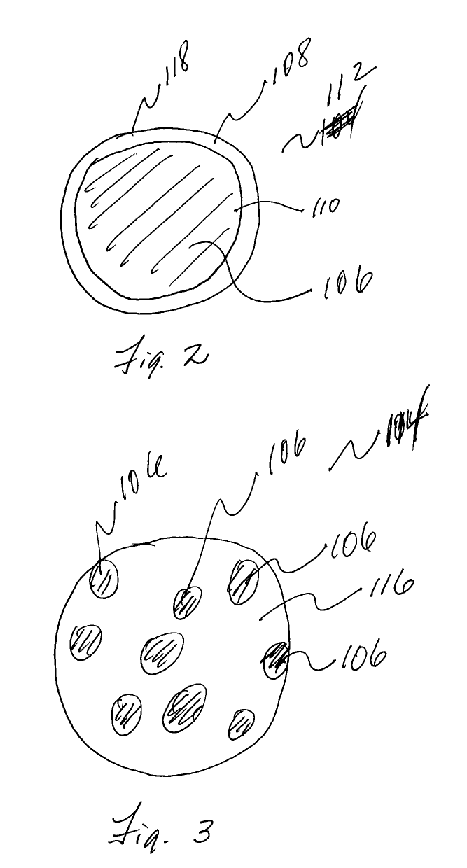

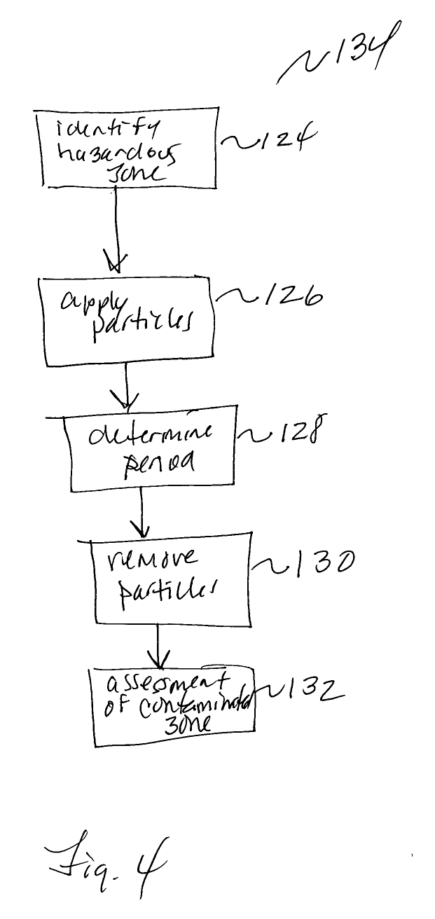

### DETAILED DESCRIPTION

One aspect of the present invention is a sorbent particle 104 comprising a polymer 102 having solubility and diffusion properties suitable for absorbing hydrophobic materials (FIG. 1). The solubility property is the ability of the polymer 102 to absorb a material. That is, the ability of the polymer to take the material within the polymer 102 mass, as opposed to excluding and/or retaining the material on the polymer 102 surface. The diffusion property of the polymer 102 is the ability to transport the material from a region of higher concentration to a region of lower concentration by random molecular motion.

Polymers are preferred for their durability, strength, abrasion resistance, absorptive capacity, diffusion properties and relatively benign properties to living organisms. Polymers and polymer compositions and their chemical and physical properties (including but not limited to durability, strength, abrasion resistance, absorptive and diffusion properties and parameters, and bio-capability with living organisms) suitable for various aspects, embodiments and configurations of the present invention are disclosed in Polymer Handbook 4^{th} Edition, edited by J. Brandrup, E. H. Immergut, and E. A. Grulke, Willey-Interscience, ©1999 and Physical Properties of Polymers Handbook 2^{nd} Edition, by J. E. Mark, Springer ©2006 both of which are incorporated herewith by this reference.

Preferably, the polymer 102 is any polymer having substantially hydrophobic properties. The polymer 102 preferably adsorbs non-polar materials having a greater solubility in nonpolar solvents than in water (a polar solvent), thereby having an oil/water partition coefficient at least greater than one. Commonly, the oil/water partition coefficient for a material is referred to in the art as the Log P value for the material. The Log P is the ratio of the amounts of material partitioned between water and octanol, more precisely the log₁₀ of the ratio of the concentration partitioned in octanol to concentration partitioned in water, as expressed by the following mathematical equation:

Log₁₀ P=Log₁₀([concentration in octanol]/[concentration in water]) (1)

Many environmentally hazardous materials are hydrophobic, that is, they have a Log P value at least greater than about zero. Non-limiting examples of such hazardous hydrophobic materials are polychlorinated biphenyls (“PCB's”), dioxins, pesticides, pharmaceuticals, organometallics (such as, methyl mercury and tetraethyl lead), and synthetic organic compounds. Such strongly hydrophobic materials are substantially immiscible with and substantially insoluble in water. Examples of such hydrophobic materials, without limitation are: 2-(3,5-dichlorophenyl)-2-(2,2,2-trichloroethyl) oxirane (Log P of about 4), 1,2,3,6,8,9-hexachloro-dibenzofuran (Log P of about 7), 2,2′,3,3′,4,4′,6,6′-octachloro-1,1′-biphenyl (Log P of about 7), tetrachlorobenze (Log P of about 5), dibenzo (1,4) dioxin (Log P of about 4), hexafluoromethane (Log P of about 2) and mithramycin (Log P of about 1).

In a preferred embodiment, the polymer 102 absorbs materials having a Log P greater than about Log P 0, more preferred the polymer absorbs materials having a Log P greater than about than about Log P 1. In an even more preferred embodiment, the polymer absorbs materials having a Log P greater than about Log P 2.

Returning to the polymer 102, the ability of the polymer 102 to adsorb a hydrophobic hazardous material is substantially related to the Log P value of the hazardous material. Preferably, the polymer 102 has a solubility property which substantially favors the absorption of one or more hazardous materials. In a preferred embodiment, the polymer 102 is selected to preferentially absorb a pre-selected hydrophobic hazardous material and/or variety of pre-selected hazardous materials having a predetermined Log P value and/or range of Log P values. In a more preferred embodiment, the polymer 102 has an equilibrium partitioning with the hydrophobic hazardous material, that is, the polymer 102 has a linear absorption isotherm.

The polymer 102 can be any polymeric material. Preferably, the polymer 102 is one or more of a homopolymer, copolymer, polymer mixture, polymer alloy, or combination thereof. The polymer 102 comprises one or more of polyolefins, polystyrenes, polyvinyls, polyacrylics, polyhalo-olefins, polydienes, polyoxides/esthers/acetals, polysulfides, polyesters/thioesters, polyamides/thioamides, polyurethanes/thiourethanes, polyureas/thioureas, polyimides/thioimides, polyanhydrides/thianhydrides, polycarbonates/thiocarbonates, polyimines, polysiloxanes/silanes, polyphosphazenes, polyketones/thioketones, polysulfones/sulfoxides/sulfonates/sulfoamides, polyphylenes, and mixtures thereof. In a preferred embodiment, the polymer comprises at least one of polyethylene, high-density polyethylene, low-density polyethylene, polypropylene, nylon and mixtures thereof.

In one embodiment, the polymer 102 is formed into a polymeric particle 104. In another embodiment of the present invention, the polymer 102 substantially encapsulates an active ingredient 106 to form the polymeric particle 104. The active ingredient 106 is any material capable of substantially absorbing, adsorbing, reacting with, deactivating and/or decomposing the hazardous material. Non-limiting examples of the active ingredient 106 are forms of activated carbon, forms of granular activated carbon, zero valent metals, forms of zero-valent iron, microbes, bacterium, fungus, forms of white rot fungus, and mixtures thereof. The zero-valent metal, including zero-valent iron, can be in the form of powders, particles, filings, or solid shapes such as, but not limited to, a sphere. The zero-valent metal, including iron, comprises substantially commercially available substantially pure forms of the metal, alloys of the metal and physical and/or metallurgical mixtures comprising the metal (including, but not limited to scrap metal).

The encapsulation is one of core-shell encapsulation (FIG. 2), matrix encapsulation (FIG. 3) and combinations thereof. A core-shell encapsulated particle 112 comprises a core 110 and a shell 108 having a core-shell particle surface 118. The shell 108 substantially comprises the polymer 102 and is substantially free of any active ingredient 106. The core substantially comprises the active ingredient 106 and is substantially free of any polymer 102. The shell 108 substantially surrounds by the core 110. In one embodiment, the shell 108 comprises a plurality of polymeric layers, one layer positioned on top of another. The polymeric layers can comprise the same polymeric material or polymeric materials that differ. Matrix encapsulated particles 114 comprise the active ingredient 106 intermixed within a matrix 116 comprising the polymer 102 and have a matrix surface 120 comprising substantially the polymer 102. In one configuration, the matrix surface comprises the polymer 102 and at least some of active ingredient 106.

The particles 104 can have any shape. A preferred polymer particle 104 shape is selected from the group consisting of shapes substantially resembling spheres, cylinders, tri-lobes, poly-lobes, tubes, and combinations thereof. Non-limiting examples of polymeric particle shapes comprising a combination of one or more shapes are tri-lobe and poly-lobe cylinders and/or tubes.

The polymeric particle 104 has a size, a volume, a surface area and a mass. The polymeric particle 104 size is at least about ⅛ of an inch. In a preferred embodiment, the polymeric particle 104 ranges from about ¼ inch to about 2 inches, even more preferred from about ⅜ inch to about 1 inch. The polymeric particle 104 ratio of mass/volume is at least about 0.5. In a preferred embodiment, the mass/volume ratio for the polymeric particle is at least about 0.7, even more preferred the mass/volume ratio is at least about 1. The surface area of particle 104 ranges from about 1×10⁻⁴ ft² to about 2 ft². In a preferred embodiment, the particle 104 surface area ranges from about 1×10⁻³ ft² to about 1 ft² and even more preferred from about 2×10⁻² ft² to about 0.5 ft².

Another aspect of the present invention is a process 134 for treating a contaminated zone 122 containing a dangerous level of at least one hazardous material with a plurality of polymeric particles 104. The contaminated zone 122 can comprise well waters, geothermal waters, surface waters (such as water from lakes, ponds, streams, rivers, land-locked seas) and wetlands and sediments associated therewith, agricultural waters and wetlands and sediments associated therewith, wastewater associated with industrial process and wetlands and sediments exposed to the industrial wastewater, coastal waters (such as, seas and oceans) and wetlands and sediments associated therewith, and landfills, disposal site, hazardous material spillage sites and hazardous material leachate outbreak sites associated therewith.

In step 124, the contaminated zone 122 is identified. The identification of the contaminated zone 122 includes at least one or more of: a) determining the one or more hazardous materials contained within the zone 122; b) determining the level of contamination with the zone 122; c) determining the location and size of the contaminated zone 122; and d) determining mass of hazardous material(s) requiring removal.

Item a) of step 124 comprises an analysis of the contaminated zone 122 to determine the chemical composition of the hazardous material and/or materials contained therein (hereafter, the term hazardous material will be used throughout to refer to one or more hazardous materials unless indicated differently). The chemical composition of the hazardous material is utilized in selecting the appropriate polymeric particle 104. The polymer 102 is selected to have one or both of a high degree of solubility and diffusion of the hazardous material. Furthermore, if the particle 104 includes one or more active ingredients 106, the active ingredient(s) 106 is selected to have a high efficiency for removing and/or destroying the hazardous material. For particles 104 having the active ingredient 106, the solubility and/or diffusion properties of the polymer 102 are important for providing hazardous material to the active ingredient 106 encapsulated within the polymer 102. The greater one or both of the solubility and diffusion properties of the polymer 102 for hazardous material the greater the amount of hazardous material being delivered to the active ingredient 106 for removal (or destruction). In one preferred embodiment, the polymer 102 is selected for sufficiently rapid and/or continuous supplying of the hazardous material to active ingredient 106. In another preferred embodiment, the polymer 102 is selected for sufficiently rapid and/or continuous absorption of the hazardous material, up to about the saturation point of the hazardous point for polymeric material 102.

Item b) of step 124 comprises an analytical determination of the amount of contamination within the contaminated zone 122. More specifically, item b) comprises analytically determining at least one of the concentration level and total mass of hazardous material within the contamination zone 122. The analytical methods known to those of ordinary skill are suitable for determining the degree of contamination, preferred are the methods promulgated by civil authorities for assessing the degree of hazardous material contamination. Suitable analytical methods are available in U.S. 40 C.F.R. entitled “Protection of the Environment” which is incorporated herein by this reference. More specifically, sections 136, 304, and 401-503 of U.S. 40 C.F.R. related to analytical, testing, and surveying methods are incorporated herein by this reference.

Item c) of step 124 comprises surveying the zone 122 to determine its geographical location and area, as well as its vertical positioning. In addition to standard surveying methods known to those of skill within the art, item c) may also include item b) to determine concentration profiles within the geographical surveyed area and/or vertical positioning of the contaminated zone 122. In one configuration, item d) comprises statistical methods and/or models for determining the contaminated zone 122 geographical location and/or concentration profile.

Item d) of step 124 comprises determining a mass of hazardous material contained within the contaminated zone 122. In one configuration, item d) comprises a mathematical computational method and/or modeling for determining the mass of hazardous material contained within the contaminated zone 122. In another configuration, item d) comprises a statistical method and/or modeling of contaminated zone 122 to determine the mass of hazardous material contained therein. In yet another configuration, item d) comprises a combination of mathematical and statistical computations and/or models.

In step 126, the plurality of particles 104 is contacted with the contaminated zone 122. In one embodiment, the particles 104 are spread by any method known within the art for spreading particles 104 over a geographical area. In a preferred embodiment, the plurality of particles 104 is contacted with contaminated zone 122 by spreading by one or more of: hand; mechanical apparatus (e.g., spreading machine); dispensing from a car, truck, tractor, plane or boat; and a combination thereof. In one configuration, the particles 104 are contacted with a surface 136 of the contaminated zone 122, with time the particles disperse throughout the contaminated zone 122 due to natural mixing and/or density of the particles 104. In a preferred configuration, the contacting of particles 104 with the contaminated zone 122 includes dispersing the plurality of particles 104 throughout zone 122. While not wanting to be limited by example, the contacting step 126 includes one of: injecting the particles 104 into the zone 122; tilling the particles 104 into the zone 122; burying the particles 104 within the zone 122; mixing the particles 122 with at least some of the contents of zone 122; and combinations thereof.

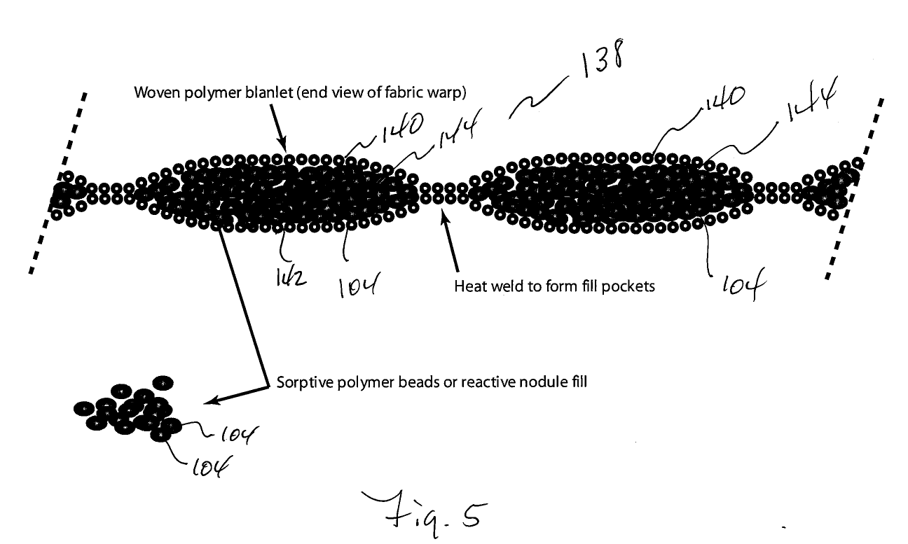

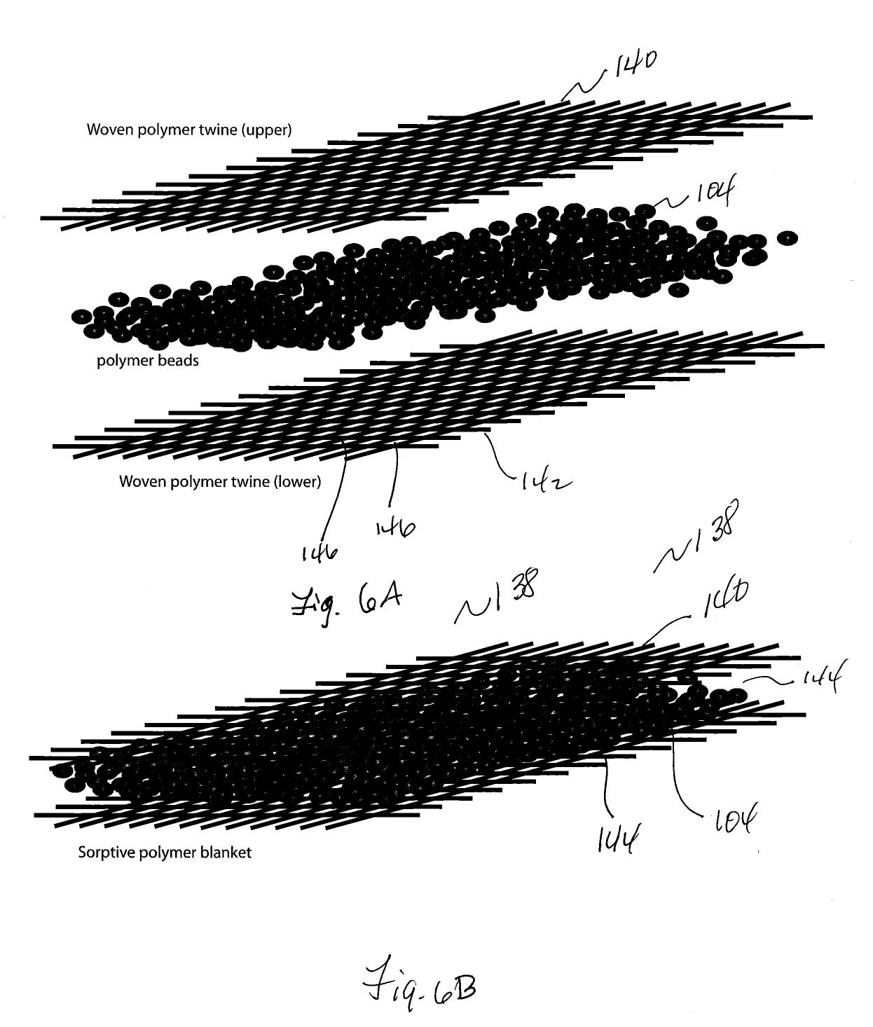

Another aspect of the invention comprises a netting system 138 or matting system for contacting the particles 104 with the contaminated zone 122. The netting system 138 comprises the plurality of particles 104 positioned between first 140 and second 142 opposing nets. The first 140 and second 142 nets substantially encase and restrain the plurality of particles 104 within a void volume 144 (FIGS. 6A and 6B) or a plurality of void volumes 144 (FIG. 5) which define at least one void volume enclosed between first 140 and second 142 nets.

The nets 140, 142 or matting system can comprise any material having sufficient tensile strength to retain the plurality of particles 104. In one embodiment, the nets 140, 142 comprise one of a cellulosic material, a polymeric material, a metallic material or a combination thereof. In a preferred embodiment, the nets 140, 142 or mats comprise one of a polyethylene material, a polyethylene coated metallic cable and/or rope, a metallic cable and/or rope and a combination thereof (such as, but not limited to a net comprising interwoven polyethylene and metallic cables and/or rope). Constructing the nets 140, 142 with at least one polymer having an absorptive property for the hazardous material increases the hazardous material removal ability of the netting system 138. As used herein, a rope comprises a length of fibers, twisted or braided together and a cable comprises two or more ropes running side-by-side and bonded, twisted, or braided together to form a single assembly. Henceforth, unless indicated differently, the terms rope and cable will be used interchangeably throughout, thereby indicating that robes and cables can be used interchangeably in the netting system 138 embodiments of the invention.

The nets 140, 142 comprise a plurality of ropes 148 interwoven to form a mesh structure having a plurality of mesh voids 146. Preferably, the mesh void 146 is of smaller size than the particles 104. That is, at least most, if not all, of the particles 104 are preferably substantially at least larger in size than the mesh void 146. In one configuration, the nets 140 are 142 are interwoven and/or conjoined to form the single void 144 depicted in FIG. 6B or a plurality of voids 144 depicted in FIG. 5.

The netting system 138 can be contacted with the contaminated zone 122 by any suitable method, such as, but not limited to positioning on the surface 118 of the contaminated zone 122 or positioning within the contaminated zone 122 (such as, burying within a sediment or anchoring within a body of water). In a preferred embodiment, after positioning the netting system 138 on the surface of the contaminated zone 122, pressure is applied to the netting system 138 to at least substantially imbed at least some, if not most, of the netting system 128 in the contaminated zone 122. Preferably, at least most, if not all of the netting system 138 is embedded in the contaminated zone 122. In one configuration, the plurality of particles 104 and/or the netting system 138 has intrinsic buoyancy. To decrease or completely counter the intrinsic buoyancy, the particles 104 and/or the netting system 138 further comprise one or more of the active ingredient 106, a non-active material (such as, pea stone), rope comprising metal and combinations thereof. In another configuration, the intrinsic buoyancy is countered by the accumulation of one of a microbial and fungal biomass on the particles 104 and/or the netting system 138. The mesh structure of the netting system allows for greater contact of the particles 104 with the contaminated zone 122 than systems lacking a mesh structure, such as, woven or non-woven textile materials. Furthermore, the woven and non-woven textile materials are more prone to the entrainment of gasses, thereby having a greater tendency to be more buoyant than the netting system 138. Woven and non-woven textile remediation technologies are disclosed in “Reactive Core Mat™ Granular Activated Carbon (GAC) Core” ©2006, “Apatite Reactive Core Mat™” ©2004, “Orangoclay Reactive Core Mat™” (no date), “Site and Sediment Remediation Products and Technologies” ©2007, and “Installation Guidelines Bentomat® Claymax®” ©2006, all published by CETCO®, each of which is incorporated herein by this reference.

In step 128, the plurality of particles 104 and/or netting system 138 remain in contact with the contaminated zone 122 for a predetermined period. The period is at least about one week. In one embodiment, the period ranges from about 1 month to about 60 months. In a preferred embodiment, the period ranges from about 6 months to about 18 months.

The period is affected by one of more of the following parameters: the particle 104 surface area; the absorption properties of the polymer 102 (that is, the solubility of the hazardous material in the polymer 102); the diffusion properties of polymer 102 (that is, the diffusion coefficient of the hazardous material in the polymer 102); the hazardous material concentration in contact with the plurality of particles 104; the contaminated zone 122 temperature; the mass of particles 104, netting system 138, and active ingredient 106 in contact with the contaminated zone 122; and the kinetics of the polymer 102 absorption and active ingredient 106 removal of the hazardous material. More specifically, the larger the total surface of the plurality of particles 104 in contact with the contaminated zone 122 the greater the amount of hazardous material removed. Similarly, the greater the solubility of the hazardous material in the polymer 102, the lager the amount of hazardous material removed per unit (such as, per mass and/or volume) of the polymer 102. Furthermore, for most particle 102 systems a greater amount (that is, mass) of the hazardous material is removed over a period from a contaminated zone 122 having a higher concentration than a lower concentration of the hazardous material. In most instances, the greater the contaminated zone 122 temperature the rapidly the polymer 102 absorbs and the active ingredient 106 removes the hazardous material, that is, the greater the contaminated zone 122 temperature the shorter the period required to remove a given mass of hazardous material. A greater mass hazardous material is removed from the zone 122 the greater the total mass of one or more of the plurality of particles 104, the active ingredient 106 and netting system 138 in contact with the contaminated zone 122 in contact with the contaminated zone 122. Furthermore regarding the kinetics of the polymer 102 absorption and active ingredient 106 removal of the hazardous material, the greater the 102 absorption and diffusion of the hazardous material in the polymer 102 the more rapidly the hazardous material is delivered to the active ingredient 106 for decomposition and/or adsorption. Still further, the more rapidly the active ingredient 106 decomposes and/or adsorbs the hazardous material the shorter the period for removing a given mass of hazardous material.

In one embodiment, the period is determined mathematically or statistically from one or more of the above parameters. In one configuration, the period is determined by one of a mathematical and/or a statistical computational and/or modeling method using one or more of the above parameters.

In yet another embodiment, the period is determined by monitoring the amount of hazardous material in the contaminated zone 122. The period ends when the amount of hazardous material reaches a predetermine value. The amount of hazardous material in the contaminated zone 122 is determined by one or more of the methods of step 124.

In step 130, the plurality of particles 104 and/or the netting system 138 are removed from the contaminated zone 122. The netting system 138 is removed by any of the methods known within the art for removing a netting system from one of water, a sediment zone, and/or an earthen zone. In one configuration, the plurality of particles 104 are removed by passing a magnet over the contaminated area containing the particles 104 having a magnetic substance (such as, iron). The magnetic particles 104 attract and adhere to the magnetic. The particles 104 adhered to the magnetic are removed. The magnet is repeatedly passed over the contaminate zone 122 until at least most, if not all, of the magnetic particles 104 dispersed in step 126 are recovered from contaminated zone 122. In another configuration, a solid separation process (such as filtering or floatation) is use to recover the particles 104.

In step 132, one or more of the hazardous material assessment methods is used to determine the hazardous material content of the contaminated zone 122. If the hazardous material level is substantially about at or below a level determined to be safe by the regulatory authority having jurisdiction over the contaminated area, further application of the particles 104 and/or netting system 138 is not required. That is steps 124, 126, 128, 130 and 132 are not repeated. However, if the hazardous material level is at least about equal to or above the level determined to be hazardous by the responsible regulatory authority, steps 124, 126, 128, 130 and 132 are repeated.

In one embodiment, the removed particles 104 and/or netting system 138 are disposed in a landfill or by incineration by an agency certified handle such materials. In another embodiment, for removed particles 104 and/or netting system 138 having a safe level of hazardous materials the particles 104 and netting 138 can be re-used or disposed with other non-hazardous waste.

In another aspect of the present invention, the particles 104 and/or netting system 138 removes hazardous materials comprising metals, inorganic non-metals and combinations thereof. Non-limiting examples of hazardous metals and non-metals are: uranium, mercury, cadmium, thallium, germanium, antimony, bismuth, selenium, tellurium, polonium, lanthanum and actinium group elements, arsenic, radioactive materials, and compounds and mixtures thereof.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. The features of the embodiments of the invention may be combined in alternate embodiments other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations, combinations, and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A process for treating a contaminated site, comprising the steps of:
a) identifying the contaminated site containing a hazardous material at a dangerous level;
b) applying a plurality of particles to the contaminated site, wherein applying includes contacting the plurality of particles with the contaminated site;
c) maintaining the plurality of particles in contact with the contaminated site for a predetermined period time;
d) removing the particles from the contaminated site; and
e) determining, after step d), the hazardous material content of the contaminated site.

2. A material for treating a contaminated site, comprising:
a polymeric particle comprising a polymer having a solubility property favoring the absorption of one or more hydrophobic materials, wherein the hydrophobic material is an environmental hazard.

3. The material of claim 2, wherein the polymer encapsulates an active ingredient, wherein the polymeric particle comprises one of a core-shell and a matrix encapsulation of the active ingredient and wherein the active ingredient comprises at least one of activated carbon, granular activated carbon, zero-valent iron, bacteria, fungus, white rot fungus, and mixtures thereof.

4. A device for treating a contaminated site, comprising;
a retention system having a plurality of particles positioned between first and second opposing surfaces, wherein the first and second surfaces substantially encase and restrain the plurality of particles within at least one void volume positioned between the first and second nets.

5. The device of claim 4, wherein said retention system comprises a first material and a second material which blankets the plurality of particles.

6. The device of claim 5, wherein at least one of the first and second material comprises a polymeric material, a metallic material or a combination thereof.
